(19) United States
(12) Patent Application Publication
(10) Pub. No.: US 2025/0128464 A1
(43) Pub. Date: Apr. 24, 2025

(54) MULTI-LAYER FILM, COVER MATERIAL, ITS USE AND METHOD OF MANUFACTURE

(71) Applicant: Loparex Germany GmbH & Co. KG, Forchheim (DE)

(72) Inventor: Matthias Mauser, Hausen (DE)

(21) Appl. No.: 18/682,595

(22) PCT Filed: Aug. 9, 2022
(86) PCT No.: PCT/EP2022/072338

§ 371 Date: Feb. 9, 2024

(30) Foreign Application Priority Data
Aug. 10, 2021 (DE) 10 2021 120 802.5

(51) Int. Cl. B29C 48/22; B29C 48/00; B29C 48/08; B29K 23/00; B29K 77/00; B29K 509/00; B29L 9/00

(52) U.S. Cl. CPC B29C 48/22; B29C 48/0017; B29C 48/022; B29C 48/08; B29K 2023/12; B29K 2023/14; B29K 2077/00; B29K 2077/10; B29K 2509/00; B29K 2995/0081; B29K 2995/0097; B29L 2009/00

(57) ABSTRACT

In an embodiment a multilayer film includes a first layer having a polypropylene heterophasic copolymer and/or a polypropylene homopolymer, a second layer having a polyamide copolymer and/or a polyamide homopolymer and a nucleating agent and a third layer including a coupling agent, the third layer being disposed between the first layer and the second layer, wherein the multilayer film has an asymmetric layer sequence.

### CROSS-REFERENCE TO RELATED APPLICATIONS

This patent application is a national phase filing under section 371 of PCT/EP2022/072338, filed Aug. 9, 2022, which claims the priority of German patent application 102021120802.5, filed Aug. 10, 2021, each of which is incorporated herein by reference in its entirety.

### TECHNICAL FIELD

The invention relates to a multilayer film, a cover material (also referred to as waterproofing material, or sealing material) comprising the multilayer film, and methods of manufacturing and using the multilayer film and the cover material.

### BACKGROUND

A large number of multilayer films are known from the prior art, which are suitable for a wide range of technical applications.

For some of these technical applications, however, it is advantageous that the multilayer films used for this purpose are characterized by a combination of very specific mechanical properties as well as specific barrier properties. This applies in particular to multilayer films used for the manufacture of cover membranes, especially bitumen cover membranes. Such bitumen cover membranes are used for roofing, for example. The ASTM 1970 standard in the section “Standard Specification for Self-Adhering Polymer Modified Bituminous Sheet Materials Used as Steep Roofing Underlayment for Ice Dam Protection” is relevant here for the USA and Canada.

Such cover membranes comprising multilayer films are already known in the state of the art.

However, the disadvantage of these cover membranes produced using multi-layer films is that they often do not have a sufficient barrier effect against oils, especially mineral oils. Such oils are particularly constituents of bitumen compounds. Migration of these oils from the bitumen compound into the multilayer film not only causes the bituminous compound to dry out, but also reduces the adhesion of the multilayer film, so that it detaches from the bitumen compound over time.

Furthermore, the multilayer films used in the prior art for the manufacture of cover membranes are often characterized by poor mechanical properties, such as insufficient tear strength, wrinkling, poor tear propagation properties and insufficient puncture resistance. However, waterproofing membranes comprising multi-layer films, such as waterproofing membranes for roofing, place high mechanical demands on the multi-layer films, as they are exposed to high mechanical loads due to foot traffic, storage and movement of building materials, as well as the effects of the weather.

DE 102017122004 A1 relates to a multilayer film comprising a layer (a) and a layer (c), each based on at least one propylene copolymer in an amount of at least 15 wt. %, at least one propylene polymer in an amount of at least 40 wt. %, each based on the total weight of layer (a) and (c), respectively, at least one multilayer internal layer (b) based on at least one homo- and/or copolyamide having isophorone diamine units as polyamide component, adhesion promoter layers (d) and (e), wherein the thickness of the multilayer layer (b) is at least 50% of the total thickness of the multilayer film.

DE 102009057862 A1 relates to a multilayer film comprising a layer (a) and a layer (c), each based on at least one propylene copolymer in an amount of at least 30% by weight and at least one propylene homopolymer in an amount of at least 20% by weight, in each case based on the total weight of layer (a) and (c), respectively, these polymer components always adding up to 100% by weight. %, at least one internal layer (b) based on at least one homo- and/or Docket No. LOP-001-EH-2-Substitute Specification-copolyamide having isophorone diamine units as polyamide component, in each case one adhesion promoter layer (d) or (e) arranged between the layers (a) and (b) or (b) and (c), in each case based on at least one modified thermoplastic olefin homo- or copolymer, a waterproofing sheet comprising such a multilayer film, and its use for roof covering.

The 5-layer barrier films produced so far tend to be

Due to the thickness required to meet the mechanical requirements, the end products are subject to severe wrinkling. These wrinkles can lead to leakage in the manufactured waterproofing membranes and adhesive tapes and thus negatively affect the functionality of the products to the point of product failure.

EP 3 074 228 B1 describes a three-layer film of the same structure and for the same application. However, analogous to the description or due to missing details, it cannot be represented in this way, essential points for production are missing (nucleating agent or water bath). Such a product would roll up independently to one side, probably the polypropylene side.

EP 3 074 228 B1 describes another five-layer film but with different polypropylene outer layers.

### SUMMARY

Embodiments provide multilayer films that are characterized by both very good barrier properties to oils and very good mechanical stability.

Further embodiments provide multilayer films that are characterized by a very good barrier effect against oils and by improved mechanical properties, such as improved tear resistance, puncture resistance, low wrinkling and good tear strength, compared to known multilayer films.

Various embodiments provide a cover material comprising such a multilayer film. Yet other embodiments provide methods for the manufacture of the multilayer film and the cover material and their uses.

In a first embodiment of the invention, a multilayer film with asymmetric layer sequence is provided, comprising the layers:
a first layer comprising polypropylene heterophasic (block) copolymer and/or polypropylene homopolymer;
a second layer comprising polyamide copolymer and/or polyamide homopolymer, and a nucleating agent; wherein a third layer comprising an adhesion promoter is disposed between the first and second layers. Preferably, the multilayer film comprises the first, second and third layers and is thus a three-layer film comprising a first layer (outer layer), a second layer (outer layer) and a third layer (middle layer). A layer may comprise a single layer or a plurality of similar layers.

Without adhering to any particular theory, it is assumed that the addition of a nucleating agent as a nucleating agent for crystallite formation favors a homogeneous and fine-grained crystallite structure. It is further assumed that such a crystallite structure favors dimensionally stable plastic products, which in particular exhibit very little or no curling.

Preferably, the nucleating agent is an inorganic filler, preferably selected from the group consisting of metal oxides, metal salts, silicates and boron nitride and a mixture thereof, a filler and reinforcing agent, preferably selected from the group consisting of talc, synthetic silicas, kaolin and a mixture thereof, a colorant, a pigment or a mixture thereof. In particular, the nucleating agent is preferably talc.

Preferably, the nucleating agent has an average particle size (D50), measured by gravity liquid sedimentation according to ISO 13317-3:2001 (“Determination of particle size distribution by gravitational liquid sedimentation methods-Part 3: X-ray gravitational Docket No. LOP-001-EH-4-Substitute Specification-technique”), with a 50% degree of accumulation of 0.5 to 5 μm, preferably 0.5 to 4 μm, more preferably 1 to 3 μm, especially 1.5 to 2.5 μm.

Preferably, the nucleating agent is present in the second layer (130) in a concentration of 0.1 to 5 wt %, preferably 0.1 to 3 wt %, more preferably 0.1 to 2 wt %, in particular 0.1 to 1 wt %.

Surprisingly, the multilayer film according to the present invention has a lower tendency to wrinkle in the end products compared to the previously known 5-layer barrier films. The multilayer film can therefore be used to produce cover membranes and adhesive tapes that exhibit a high degree of impermeability and retain it over a long period of time. This effect is based, among other things, on the fact that the film can be produced comparatively thin despite compliance with the mechanical requirements of ASTM 1970, and therefore has a compressibility that resists internal winding of the film.

In addition, the multilayer film according to the present invention comprising the layer sequence polyamide/adhesion promoter/polypropylene can be coated directly on the polyamide side with the adhesive composition. Compared with coating polypropylene, direct coating of the polyamide has the advantage that polyamide is much more temperature-resistant and thus thermally induced material changes such as wrinkles occur to a lesser extent. In addition, the composite adhesion between polyamide and butyl/bitumen adhesive compounds is at least equivalent to or better than the composite adhesion of polypropylene or HDPE against such adhesive systems and helps to prevent delamination of the film and the respective adhesive system.

In addition, with the multilayer film according to the present invention, when coated on the polyamide side with adhesive compound, migration of tacifiers or oils from the bitumen- or butyl-based adhesive compounds can be largely avoided. Therefore, swelling effects and/or post-crystallization of the first layer comprising heterophasic polypropylene (block) copolymer and/or polypropylene homopolymer can also be avoided. Compared to the prior art, a bimetallic effect is therefore avoided, which leads to a so-called “curling effect” of the film and ultimately causes delamination of the film from the adhesive composition or of the film-adhesive laminate from the substrate.

Finally, when coated with adhesive on the polyamide side, especially when bitumen-based adhesives are used, the multilayer film according to the present invention is well protected against failure of the adhesion promoter layer facing the adhesive due to chemical reactions caused by the combination of oil and light.

According to the present invention, the first layer comprises any proportions of heterophasic polypropylene (block) copolymer and polypropylene homopolymer.

Preferably, the first layer contains at least 40% by weight of homo-polypropylene, in particular in a range of 50 to 90% by weight. This further improves the mechanical strength and temperature resistance of the multilayer film.

The second layer may comprise any proportions of polyamide copolymer and/or polyamide homopolymer.

Homo-polyamides, unlike copolyamides, can be described by means of a single repeat unit. The homo-polyamides and/or copolyamides may be selected from a group comprising thermoplastic aliphatic, partially aromatic and aromatic homo- or copolyamides. These homo-polyamides and copolyamides may be selected from diamines, such as aliphatic diamines having two to ten carbon atoms, in particular hexamethylenediamine and/or isophoronediamine, and aromatic diamines having six to ten carbon atoms, in particular p-pheylenediamine, as well as dicarboxylic acids, aliphatic and aromatic dicarboxylic acids with six to fourteen carbon atoms, for example adipic acid, terephthalic acid or isoterephthalic acid, and lactams, for example ε-caprolactam. For example, polyamide 6, polyamide 12, polyamide 66, polyamide 61, polyamide 6T, polyamide 6/IPDI copolymers thereof or blends of at least two of the polyamides can be used as polyamides.

The homo-polyamide preferably comprises a compound selected from a group consisting of polyamide 6, polyamide 66, and a combination thereof. The homo-polyamide may comprise at least 80% by weight or all of these compounds, in particular polyamide 6, which can be rooted back to ε-caprolactam.

The copolyamide is preferably a copolyamide containing isophorone diamine units. An example of such a copolyamide is polyamide 6/IPDI. It may contain 1 to 10 wt %, in particular 1.8 to 7 wt %, of isophorone diamine units (IPD), which are present together with isophthalic acid (I) in the IPDI. The 1,3 arrangement of the functional groups in the isophorone diamine (3-aminomethyl-3,5,5-trimethylcyclohexylamine) and in the isophthalic acid (1,3-benzodicarboxylic acid) result in an amorphous polyamide. This gives higher tear strength and toughness than polyamides with high crystallinity.

In one embodiment, the second layer comprises a layer comprising polyamide copolymer.

In one embodiment, the second layer comprises multiple layers, wherein individual layers comprise homopolyamide, preferably polyamide 6. Preferably, the amount of homopolyamide, preferably polyamide 6, relative to the total amount of polyamide in all layers of the second layer (130) is up to 65 wt %, preferably 1 to 49 wt %, more preferably 1 to 25 wt %, more preferably 1 to 15 wt %, more preferably 1 to 10 wt %, more preferably 3 to 9 wt %.

According to embodiments of the invention, the multilayer comprises a third layer disposed between the first and second layers comprising a coupling agent. The adhesion promoter may comprise or consist of a material selected from a group consisting of thermoplastic polymers, organic acids, organic acid anhydrides, and mixtures and compounds thereof. Organic acids or acid anhydrides are particularly selected from carboxylic acids and carboxylic acid anhydrides. For example, the adhesion promoter may be a modified thermoplastic polymer, in particular a modified polyolefin homo-polymer or polyolefin copolymer, for example a modified propylene homo-polymer, propylene copolymer, ethylene homo-polymer, ethylene vinyl alcohol copolymer or ethylene vinyl acetate copolymer modified with at least one organic acid or organic acid anhydride, for example maleic anhydride.

Preferably, the coupling agent is a coupling agent based on maleic anhydride-grafted homo-polypropylene. An adhesion promoter layer can also consist of at least 70% by weight, in particular at least 80% by weight, or completely.

In addition, the first layer, second layer and third layer may each contain independently selected additives, if necessary. These additives may be selected from a group comprising antioxidants, antiblocking agents, antifogging agents, antistatic agents, antimicrobial agents, light stabilizers, UV absorbers, UV filters, dyes, color pigments, stabilizers, in particular heat stabilizers, process stabilizers and UV and/or light stabilizers, preferably based on at least one sterically hindered amine (HALS), process auxiliaries, flame retardants, nucleating agents, crystallization agents, in particular crystal nucleating agents, lubricants, optical brighteners, flexibilizers, sealing agents, plasticizers, silanes, spacers, fillers, peel additives, waxes, wetting agents, surface-active compounds, preferably surfactants, dispersants and combinations thereof.

The first layer, second layer and third layer may each independently contain 0.01 to 30% by weight, in particular 0.1 to 20% by weight, of one or more of the above additives. For example, the first layer may contain 5 to 20 wt %, in particular 5 to 15 wt %, for example 5 wt %, of dyes. It is also advantageous for protecting the multilayer film if the first outer layer also contains a UV stabilizer, for example in the range of 0.5 to 10 wt %, in particular 1 to 7 wt %, for example 5 wt %.

Preferably, the thickness of the second layer relative to the total thickness of the first layer, second layer and third layer is 20% to 75%, preferably 30% to 70%, more preferably 45% to 68%.

Preferably, the total thickness of the multilayer film is 40 μm to 140 μm, preferably 50 μm to 130 μm, more preferably 55 μm to 120 μm.

Preferably, the tear strength of the multilayer membrane is more than 110 N according to ASTM 1970/ASTM D2523. ASTM 1970 specifies the properties to be achieved, while ASTM D 2523 describes the measurement method, test specimens, etc. to be used under the section “Standard Practice for Testing Load-Strain Properties of Roofing Membranes”.

In a second embodiment of the present invention, a method for making the multilayer film according to the first embodiment is provided.

According to embodiments of the invention, at least the first layer, the second layer and the third layer arranged in between are produced in one process step by coextrusion. The multilayer film is formed in the process.

Coextrusion can be carried out in particular in the form of blown film coextrusion. This process and the apparatus suitable for it are known to the person skilled in the art. The multilayer film according to the application is therefore preferably a so-called blown film, in particular a three-layer blown film.

Insofar as the multilayer film comprises an adhesive layer and optionally also a protective layer or protective film, these layers can be produced in at least one further process step after coextrusion.

The process can be used to produce a multilayer film according to at least one embodiment according to the application. The explanations given above therefore also apply to the manufacturing process.

In a third embodiment of the present invention, there is provided a cover material comprising a multilayer film according to the first embodiment of the invention and an adhesive composition. Preferably, the tacky composition is bitumen or a self-adhesive sealing composition. Preferably, the tacky composition is applied to the second layer.

In a fourth embodiment of the present invention, the use of the multilayer film according to the first embodiment is provided for coating, for making cover materials or an adhesive tape.

In a fifth embodiment of the present invention, the use of the waterproofing material according to the third embodiment is provided as a building material, for roofing, for exterior cladding, for covering buildings or parts of buildings, or for covering pipes.

### BRIEF DESCRIPTION OF THE DRAWINGS

FIG. 1 shows a multilayer film (100) with asymmetric layer sequence comprising a first layer (110) comprising polypropylene copolymer and/or polypropylene homopolymer; a second layer (130) comprising polyamide copolymer and/or polyamide homopolymer; wherein between the first layer (110) and the second layer (130) there is a third layer (120) comprising an adhesion promoter.

FIG. 2 shows a cover material (200) comprising a multilayer film (100) as shown in FIG. 1 and a tacky composition (140) disposed on the second layer.

### DETAILED DESCRIPTION OF ILLUSTRATIVE EMBODIMENTS

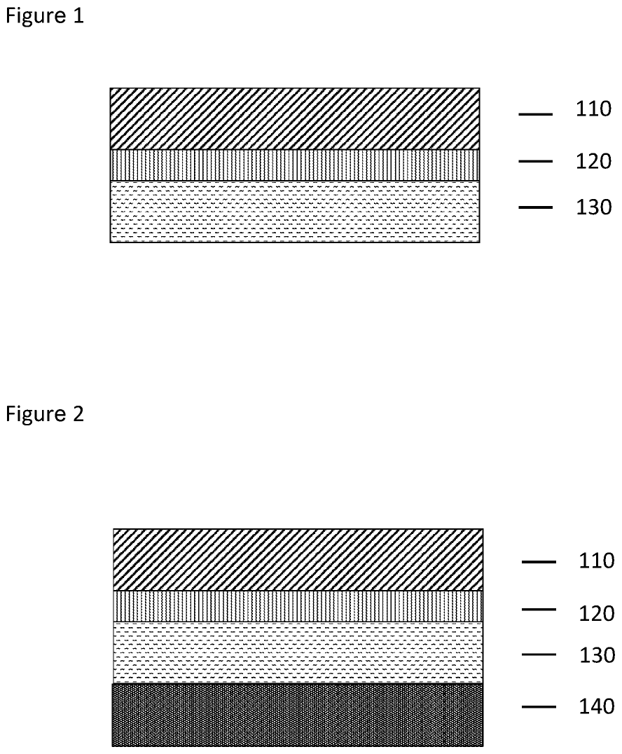

FIG. 1 shows a schematic cross-section through a multilayer film 100 according to at least one embodiment according to the application. The multilayer film 100 comprises a first layer 110, a second layer 130, and a middle layer 120. The middle layer 120 is an adhesion promoter layer. In a preferred embodiment, the multilayer film is a three-layer film comprising a first outer layer 110, a second outer layer 130, and a middle layer 120.

The multilayer film 100 may have a total thickness of 40 to 140 μm, preferably 50 to 130 μm, in particular 55 to 120 μm. The first layer 110 may have a layer thickness of 5 to 50 μm, in particular 10 to 30 μm. The third layer comprising adhesion promoters can have a layer thickness of 1 to 30 μm, in particular 2 to 20 μm. The second layer 130 can have a layer thickness of 5 to 100 μm, preferably 10 to 80 μm, in particular 20 to 80 μm.

The first layer 110 comprises homo polypropylene, for example 40 to 60 wt %, and polypropylene heterophasic (block) copolymer (ethylene content 7-9 wt %), for example 15 to 30 wt % polypropylene heterophasic (block) copolymer (ethylene content 7-9 wt %). The second layer 130 comprises at least 30 wt % copolyamide, for example 80 to 100 wt % copolyamide. In particular, the copolyamide may comprise isophorone diamine units, such as polyamide 6/IPDI. The adhesion promoter layers 120 may include a polypropylene polymer modified or grafted with maleic anhydride.

The film shown in FIG. 1 may, for example, be a so-called blown film, for example a three-layer blown film. On the side of the second layer (outer layer) 130 facing away from the third layer (middle layer) 120, an adhesive layer and, if necessary, a protective layer or a protective film may be applied (not shown here).

FIG. 2 shows a schematic cross-sectional view of a sealing material 200 according to at least one embodiment. The cover material 200 comprises a multilayer film 100 as described, for example, for FIG. 1. The multilayer film 100 is laminated to an adhesive composition 140 comprising or consisting of, for example, bitumen. The cover material 200 shown in FIG. 2 may be embodied, for example, as a cover membrane, in particular a bituminous cover membrane, with the multilayer film 100 as a surface coating or surface film, and may be suitable for waterproofing or covering roofs or other parts of buildings.

In this regard, the multilayer film 100 protects the water-impermeable material 70 from harmful gases, for example atmospheric oxygen, and acts as an oil barrier, particularly during installation of the waterproofing material.

### EXAMPLES

In the examples, the abbreviations listed in Table 1 below are used:

TABLE 1

| | | | Density |
|---|---|---|---|
| Marking | Designation | Tm [° C.] | [g/cm³] |
| PP Homo | Polypropylene homopolymer | 166 | 0.9 |
| | of the company Borealis | | |
| PP HeCo | Polypropylene heterophasic | 164 | 0.9 |
| | (block) Copolymer of the | | |
| | company Braskem or Borealis | | |
| | (ethylene content 7-9 wt. %) | | |
| TPO | Polypropylene polyethylene | 140 | 0.89 |
| | Copolymer with low EModulus | | |
| HV, HV1 | Adhesion promoting | 160 | 0.9 |
| | polymer, with Maleic | | |
| | anhydride groups modified | | |
| | polypropylene Homopolymer | | |
| | of the company Mitsui | | |
| HV2 | Adhesion promoting | 63 | 0.87 |
| | polymer, with Maleic | | |
| | anhydride groups modified | | |
| | thermoplastic Elastomer | | |
| | from the company DowDuPont | | |
| CoPA | Copolyamide formed from | 212 | 1.13 |
| | eCaprolactam, isophorone | | |
| | diamine and isoterephtalic | | |
| | acid, with an isophorone | | |
| | diamine component of approx. | | |
| | 5% of the company Lanxess | | |
| HomoPA | Polyamide 6 from the | 222 | 1.14 |
| | company Lanxess | | |
| UV | UV stabilizing masterbatch | Not | 0.92 |
| additive I | of the company Constab on | specified | |
| | the basis of a sterically | | |
| | hindered Amine derivative | | |
| UV | UV stabilizing masterbatch of | Not | 0.93 |
| Additive II | the Schulmann company with | specified | |
| | a Additive proportion of 10% | | |
| Color | Color masterbatches from | Not | 1.14 |
| | various companies | specified | |

In the examples, three-layer films were produced from layers 110, 120 and 130 by blown film coextrusion. The layers had the following composition:

### Example 1

TABLE 2
Example 1 (100 μm)

| | | | Share | |
|---|---|---|---|---|
| | | | in the | Layer |
| | Description | | shift | thicknesses |
| Layer | layer | Description | [%] | [μm] |
| 130 | Polyamide 1 | CoPA | 96.5 | 16 |
| | | Anti-blocking | 2 | |
| | | agent (talc) | | |
| | | Nucleating agent | 1 | |
| | | Processing aids | 0.5 | |
| 130 | Polyamide 2 | CoPA | 98.5 | 22 |
| | | Nucleating agent | 1 | |
| | | Processing aids | 0.5 | |
| 130 | Polyamide 3 | CoPA | 68.5 | 10 |
| | | h-PA (PA6) | 30 | |
| | | Nucleating agent | 1 | |
| | | Processing aids | 1.5 | |
| 120 | Bonding agent | HV1 | 98.5 | 11 |
| | | UV2 | 1.5 | |
| 110 | Polypropylene 1 | PP-Homo | 54.5 | 8, 8, 8 |
| | | PP HeCo | 30 | |
| | | UV2 | 2 | |
| | | Color (white) | 13.5 | |
| 110 | Polypropylene 2 | PP-Homo | 52 | 17 |
| | | PP HeCo | 30 | |
| | | UV2 | 2 | |
| | | Anti-blocking | 2 | |
| | | agent (talc) | | |
| | | Processing aids | 0.5 | |
| | | Color (white) | 13.5 | |

### Example 2

TABLE 3
Example 2 (80 μm)

| | | | Share | |
|---|---|---|---|---|
| | | | in the | Layer |
| | Description | | shift | thicknesses |
| Layer 1 | layer | Description | [%] | [μm] |
| 130 | Polyamide 1 | CoPA | 96.5 | 16 |
| | | Anti-blocking | 2 | |
| | | agent (talc) | | |
| | | Nucleating agent | 1 | |
| | | Processing aids | 0.5 | |
| 130 | Polyamide 2 | CoPA | 98.5 | 22 |
| | | Nucleating agent | 1 | |
| | | Processing aids | 0.5 | |
| 130 | Polyamide 3 | CoPA | 68.5 | 10 |
| | | h-PA (PA6) | 30 | |
| | | Nucleating agent | 1 | |
| | | Processing aids | 1.5 | |
| 120 | Bonding agent | HV1 | 98.5 | 11 |
| | | UV2 | 1.5 | |
| 110 | Polypropylene 1 | PP-Homo | 54.5 | 12 (3 × 4) |
| | | PP HeCo | 30 | |
| | | UV stabilizer | 2 | |
| | | Color (white) | 13.5 | |
| 110 | Polypropylene 2 | PP-Homo | 52 | 9 |
| | | PP HeCo | 30 | |
| | | UV stabilizer | 2 | |
| | | Anti-blocking | 2 | |
| | | agent (talc) | | |
| | | Processing aids | 0.5 | |
| | | Color (white) | 13.5 | |

### COMPARATIVE EXAMPLES

In the Comparative Examples, five-layer films were produced from successive layers 1 to 5 by blown film coextrusion. The layers had the following composition:

### Comparative Example 1

TABLE 4
Comparative Example 1

| | | | Layer | Total |
|---|---|---|---|---|
| | | Proportion | thickness | thickness |
| Layer | Material | [wt. %] | [μm] | [μm] |
| 1 | PP Homo | 30 | 44 | 125 |
| | PP HeCo | 42.5 | | |
| | UV additive I | 2.5 | | |
| | Color | 5 | | |
| | EBA | 20 | | |
| 2 | HV1 | 74 | 6 | |
| | UV Additive II | 1 | | |
| | PP Homo | 25 | | |
| 3 | CoPA | 100 | 25 | |
| 4 | HV1 | 74 | 6 | |
| | UV Additive II | 1 | | |
| | PP Homo | 25 | | |
| 5 | PP Homo | 30 | 44 | |
| | PP HeCo | 42.5 | | |
| | UV additive I | 2.5 | | |
| | Color | 5 | | |
| | EBA | 20 | | |

### Comparative Example 2

TABLE 5
Comparative Example 2

| | | | Layer | Total |
|---|---|---|---|---|
| | | Proportion | thickness | thickness |
| Layer | Material | [wt. %] | [μm] | [μm] |
| 1 | PP Homo | 30 | 34 | 100 |
| | PP HeCo | 42.5 | | |
| | UV additive I | 2.5 | | |
| | Color | 5 | | |
| | EBA | 20 | | |
| 2 | HV1 | 74 | 6 | |
| | UV Additive II | 1 | | |
| | PP Homo | 25 | | |
| 3 | CoPA | 100 | 20 | |
| 4 | HV1 | 74 | 6 | |
| | UV Additive II | 1 | | |
| | PP Homo | 25 | | |
| 5 | PP Homo | 30 | 34 | |
| | PP HeCo | 42.5 | | |
| | UV additive I | 2.5 | | |
| | Color | 5 | | |
| | EBA | 20 | | |

### Comparative Example 3

TABLE 6
Comparative Example 3

| | | | Layer | Total |
|---|---|---|---|---|
| | | Proportion | thickness | thickness |
| Layer | Material | [wt. %] | [μm] | [μm] |
| 1 | PP Homo | 30 | 27 | 80 |
| | PP HeCo | 42.5 | | |
| | UV additive I | 2.5 | | |
| | Color | 5 | | |
| | EBA | 20 | | |
| 2 | HV1 | 74 | 5 | |
| | UV Additive II | 1 | | |
| | PP Homo | 25 | | |
| 3 | CoPA | 100 | 16 | |
| 4 | HV1 | 74 | 5 | |
| | UV Additive II | 1 | | |
| | PP Homo | 25 | | |
| 5 | PP Homo | 30 | 27 | |
| | PP HeCo | 42.5 | | |
| | UV additive I | 2.5 | | |
| | Color | 5 | | |
| | EBA | 20 | | |

### Comparative Example 4

TABLE 7
Comparative Example 4

| | | | Layer | Total |
|---|---|---|---|---|
| | | Proportion | thickness | thickness |
| Layer | Material | [wt. %] | [μm] | [μm] |
| 1 | PP Homo | 30 | 44 | 125 |
| | TPO | 62.5 | | |
| | UV additive I | 2.5 | | |
| | Color | 5 | | |
| 2 | HV2 | 20 | 6 | |
| | UV Additive II | 1 | | |
| | PP Homo | 79 | | |
| 3 | CoPA | 100 | 25 | |
| 4 | HV2 | 20 | 6 | |
| | UV Additive II | 1 | | |
| | PP Homo | 79 | | |
| 5 | PP Homo | 30 | 44 | |
| | TPO | 62.5 | | |
| | UV additive I | 2.5 | | |
| | Color | 5 | | |

### Comparative Example 5

TABLE 8
Comparative Example 5

| | | | Layer | Total |
|---|---|---|---|---|
| | | Proportion | thickness | thickness |
| Layer | Material | [wt. %] | [μm] | [μm] |
| 1 | PP Homo | 30 | 35 | 100 |
| | TPO | 62.5 | | |
| | UV additive I | 2.5 | | |
| | Color | 5 | | |
| 2 | HV2 | 20 | 5 | |
| | UV Additive II | 1 | | |
| | PP Homo | 79 | | |
| 3 | CoPA | 100 | 20 | |
| 4 | HV2 | 20 | 5 | |
| | UV Additive II | 1 | | |
| | PP Homo | 79 | | |
| 5 | PP Homo | 30 | 35 | |
| | TPO | 54 | | |
| | UV additive I | 2.5 | | |
| | Color | 13.5 | | |

### Evaluation of the Slides

The films were tested for their tear strength at break according to ASTM 1970.

TABLE 9

| | | | Comparative |
|---|---|---|---|
| Try | Example 1 | Example 2 | Example 1 |
| Bond adhesion vs. | 70.5 Adhesive | 70.1 Cohesion | 68.8 Adhesive |
| bitumen I [N] | fracture | break | fracture |
| Bond adhesion vs. | 110.8 Cohesion | 115 Cohesion | 93.1 Cohesion |
| bitumen II [N] | break | break | fracture |

Bitumen I and Bitumen II are Bitumen Masses from Different Manufacturers

TABLE 10

| | | Tearing | Tearing | | |
|---|---|---|---|---|---|
| | | force at | force at | Ratio of | |
| | | break in | break in | breaking | |
| | Thickness | direction | direction | force md | ASTM |
| Film type | [μm] | md [N] | md [N] | to cd | 154 [N] |
| Example 1 | 100 | 139.1 | 128 | 1.085 | — |
| Example 2 | 80 | 142.2 | 112.4 | 1.26 | — |
| Comparative | 125 | 157 | 140 | 1.12 | 290 |
| Example 1 | | | | | |
| Comparative | 100 | 132 | 116 | 1.14 | 231 |
| Example 2 | | | | | |
| Comparative | 80 | 106 | 90 | 1.17 | 225 |
| Example 3 | | | | | |
| Comparative | 125 | 110.1 | 101.3 | 1.09 | 263 |
| Example 4 | | | | | |
| Comparative | 100 | 78.6 | 71.1 | 1.11 | 174 |
| Example 5 | | | | | |

1.-18. (canceled)

19. A multilayer film comprising:
a first layer comprising a polypropylene heterophasic copolymer and/or a polypropylene homopolymer;
a second layer comprising a polyamide copolymer and/or a polyamide homopolymer and a nucleating agent; and
a third layer comprising a coupling agent, the third layer being disposed between the first layer and the second layer,
wherein the multilayer film has an asymmetric layer sequence.

20. The multilayer film according to claim 19, wherein the nucleating agent comprises:
an inorganic filler selected from the group consisting of metal oxides, metal salts, silicates, boron nitrides and a mixture thereof,
a filling and reinforcing agent selected from the group consisting of talc, synthetic silicas, kaolin and a mixture thereof, and
a colorant, a pigment or a mixture thereof.

21. The multilayer film according to claim 19, wherein the nucleating agent has an average particle size (D50), measured by gravity liquid sedimentation according to ISO 13317-3:2001 (“Determination of particle size distribution by gravitational liquid sedimentation methods-Part 3: X-ray gravitational technique”), with an accumulation degree of 50% of 0.5 to 5 μm.

22. The multilayer film according to claim 19, wherein the nucleating agent is present in the second layer in a concentration of 0.1 to 5% by weight.

23. The multilayer film according to claim 19, wherein the multilayer film consist of the first layer, the second layer, and the third layer.

24. The multilayer film according to claim 19, wherein the second layer consists of a layer comprising a polyamide copolymer.

25. The multilayer film according to claim 19, wherein the second layer consists of multiple layers and comprises individual layers of a polyamide homopolymer.

26. The multilayer film according to claim 25, wherein an amount of polyamide homopolymer relative to an total amount of polyamide in all layers of the second layer is up to 65% by weight.

27. The multilayer film according to claim 19, wherein a thickness of the second layer relative to a total thickness of the first layer, the second layer and the third layer is 20% to 75%.

28. The multilayer film according to claim 19, wherein a total thickness of the multilayer film is 40 μm to 140 μm.

29. The multilayer film according to claim 19, wherein a tear strength of the multilayer film is more than 110 N according to ASTM 1970.

30. The multilayer film according to claim 19, wherein a ratio of a breaking force at break in a first machine direction to a transverse direction to a second machine direction is less than 1.1 according to ASTM 1970.

31. A method for manufacturing the multilayer film according to claim 19, the method comprising:
coextruding the first layer, the second layer, and the third layer.

32. A method comprising:
using of the multilayer film according to claim 19 for coating or for producing cover materials or an adhesive tape.

33. A cover material comprising:
the multilayer film according to claim 19; and
an adhesive composition.

34. The cover material according to claim 33, wherein the adhesive composition is bitumen or a self-adhesive waterproofing composition.

35. The cover material according to claim 33, wherein the adhesive composition is applied to the second layer.

36. A method comprising:
using of the cover material according to claim 33 as a building material, for roofing, for external cladding, for covering buildings or parts of buildings, or for covering pipes.
